(19) United States
(12) Patent Application Publication
(10) Pub. No.: US 2025/0019028 A1
(43) Pub. Date: Jan. 16, 2025

(54) HEAD TUBE ASSEMBLY

(71) Applicant: Huei-Chen LAI, Taichung City (TW)

(72) Inventor: Huei-Chen LAI, Taichung City (TW)

(21) Appl. No.: 18/518,226

(22) Filed: Nov. 22, 2023

(30) Foreign Application Priority Data
Jul. 10, 2023 (TW) 112125727

(51) Int. Cl. B62K 19/32; B62K 21/06; B62K 21/08

(52) U.S. Cl. CPC B62K 19/32; B62K 21/06; B62K 21/08

(57) ABSTRACT

A head tube assembly mounted between a head tube and a front fork of a vehicle includes a cup member mounted fixedly to the head tube, an insertion member, and a damping unit. The insertion member is connected co-rotatably to the front fork about an axis and includes an insertion body. The damping unit is disposed between the cup member and the insertion member, and includes inner and outer seats and a bushing. The outer seat is fixedly connected to the cup member. The inner seat is connected co-rotatably to the insertion member. The bushing is mounted on the axis between the inner and outer seats that are in frictional contact with the bushing and rotatable relative to the bushing about the axis. Each of the inner seat and the insertion body has an eccentric structure such that the insertion member drives rotation of the inner seat as being rotated.

### CROSS-REFERENCE TO RELATED APPLICATION

This application claims priority to Taiwanese Invention Patent Application No. 112125727, filed on Jul. 10, 2023, which is incorporated by reference herein in its entirety.

### FIELD

The disclosure relates to a head tube assembly, and more particularly to a head tube assembly to be mounted to a vehicle.

### BACKGROUND

Referring to FIGS. 1 and 2, a head tube assembly 9 disclosed in U.S. Pat. No. 10,421,517 is rotatably connected between a steering tube 901 and a head tube 902 of a vehicle (not shown), and provides a damping effect. The steering tube 901 is sleeved on and rotatable relative to the head tube 902. The head tube assembly 9 includes a connecting ring 91, a cup 92, a bearing unit 93, a damping unit 94, and a top cover 95. The connecting ring 91 is co-rotatably connected to the steering tube 901. The cup 92 is connected fixedly to the head tube 902, is driven thereby to rotate with the head tube 902, and includes a main body 921 having an inner surface that defines a channel 922. The bearing unit 93 is disposed in the cup 92. The damping unit 94 is disposed between the cup 92 and the steering tube 901. The top cover 95 is sleeved on and covers a portion of the cup 92, and is connected co-rotatably to the steering tube 901. The connecting ring 91 includes a body 911 having an outer surface that defines an annular passage 912. The damping unit 94 has a plurality of first damping elements 96 connected co-rotatably to the steering tube 901, and a plurality of second damping elements 97 connected co-rotatably to the head tube 902. The first damping elements 96 and the second damping elements 97 are alternatingly disposed and are connected to each other. Thus, each of the first damping elements 96 is adjacent to at least one of the second damping elements 97, and each of the second damping elements 97 is adjacent to at least one of the first damping elements 96. Each of the first damping elements 96 has a first disc portion 961 and a first coupling portion 962. For each of the first damping elements 96, the first disc portion 961 has an outer surface 963, and an inner surface (not shown) radially opposite to the outer surface 963 and defining a central hole (not shown). For each of the first damping elements 96, the first coupling portion 962 extends from the inner surface of the first disc portion 961 toward the steering tube 901 and into the passage 912 of the connecting ring 91, and engages the body 911 of the connecting ring 91 such that the first damping element 96 is driven to rotate when the connecting ring 91 is rotated by the steering tube 901. Each of the second damping elements 97 has a second disc portion 971 and a second coupling portion 972. For each of the second damping elements 97, the second disc portion 971 has an inner surface 974 defining a hole 975 and an outer surface 973 radially opposite to the inner surface 974, the second coupling portion 972 is a tab and extends from the outer surface 973 of the second disc portion 971 away from the hole 975 into the channel 922 of the cup 92 and engages the main body 921 of the cup 92 such that the second damping element 97 is driven to rotate when the cup 92 is rotated.

However, the structure of the damping unit 94 of the conventional head tube assembly 9 is relatively complex, in particular to the structure of the first damping elements 96 and the second damping elements 97 that are stacked alternatingly. Furthermore, since each of the first damping elements 96 is connected to the body 911 of the connecting ring 91 and each the second damping elements 97 is connected to the main body 921 of the cup 92, it is troublesome to sequentially assemble the damping unit 94. Consequently, it is troublesome to disassemble the first damping elements 96 and the second damping elements 97 one by one for maintenance or repair of the damping unit 94. Such procedure is time-consuming and inconvenient.

### SUMMARY

Therefore, an object of the disclosure is to provide a head tube assembly that can alleviate at least one of the drawbacks of the prior art.

According to the disclosure, a head tube assembly is adapted to be mounted between a head tube and a front fork of a vehicle. The front fork extends through the head tube and the head tube assembly, and is rotatable relative to the head tube about an axis. The head tube assembly includes a cup member, an insertion member, and a damping unit. The cup member is adapted to be mounted fixedly to the head tube. The insertion member is adapted to be connected co-rotatably to the front fork, and includes an insertion body. The insertion body has an inner abutment surface adapted to abut against the front fork, and an outer connecting surface connected to the inner abutment surface. The damping unit is disposed on the axis between the cup member and the insertion member, is connected to the insertion member, and includes an outer seat, an inner seat and a bushing. The outer seat is fixedly connected to the cup member. The inner seat is connected co-rotatably to the insertion member and has an inner connecting surface abutting against the outer connecting surface of the insertion body. The bushing is mounted on the axis between the outer seat and the inner seat. The outer seat and the inner seat are in frictional contact with the bushing and are rotatable relative to the bushing about the axis. Each of the inner seat and the insertion body has an eccentric structure such that the insertion member drives rotation of the inner seat as being rotated.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary cutaway perspective view of a conventional head tube disclosed in U.S. Pat. No. 10,421,517.

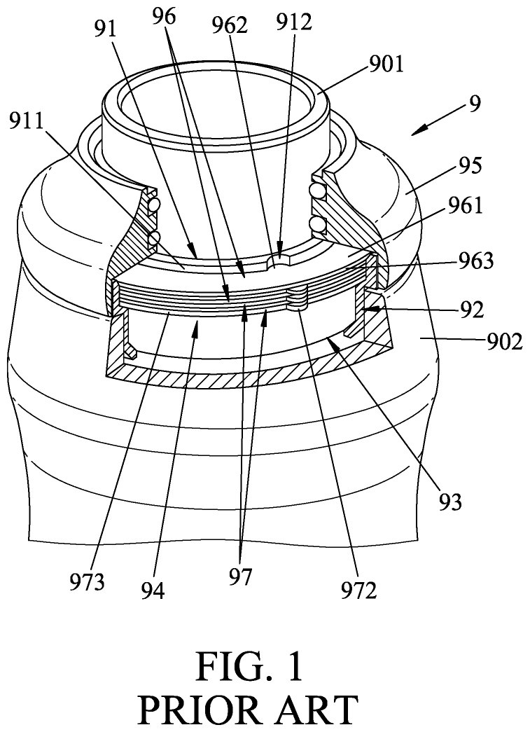

FIG. 2 is a fragmentary sectional view of the conventional head tube disclosed in U.S. Pat. No. 10,421,517.

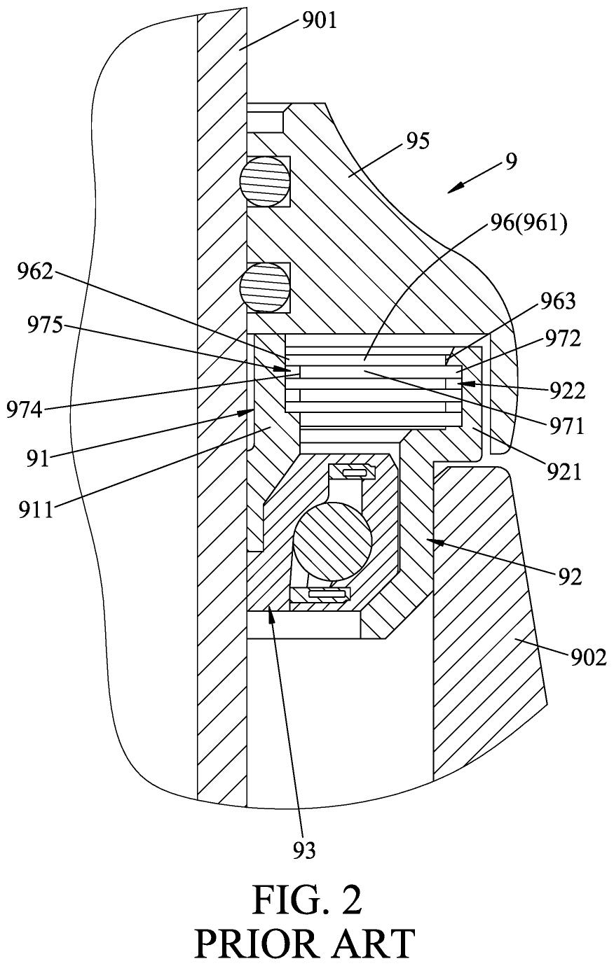

FIG. 3 is a perspective view of a head tube assembly of an embodiment according to the present disclosure being mounted to a head tube and a front fork of a vehicle.

FIG. 4 is a fragmentary sectional view of the embodiment being mounted to the head tube and the front fork.

FIG. 5 is an exploded perspective view of the head tube assembly of the embodiment.

FIG. 6 is an exploded perspective view of a damping unit of the embodiment.

FIG. 7 is another exploded perspective view of the damping unit seen from another view of angle different from FIG. 6.

FIG. 8 is an exploded sectional view of the embodiment

FIG. 9 is an enlarged view of a portion of FIG. 3.

FIG. 10 is a schematic top view of an insertion member of the embodiment.

FIG. 11 is a schematic bottom view of an inner seat of the damping unit.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently e.g., rotated 90 degrees or at other orientations and the spatially relative terms used herein may be interpreted accordingly.

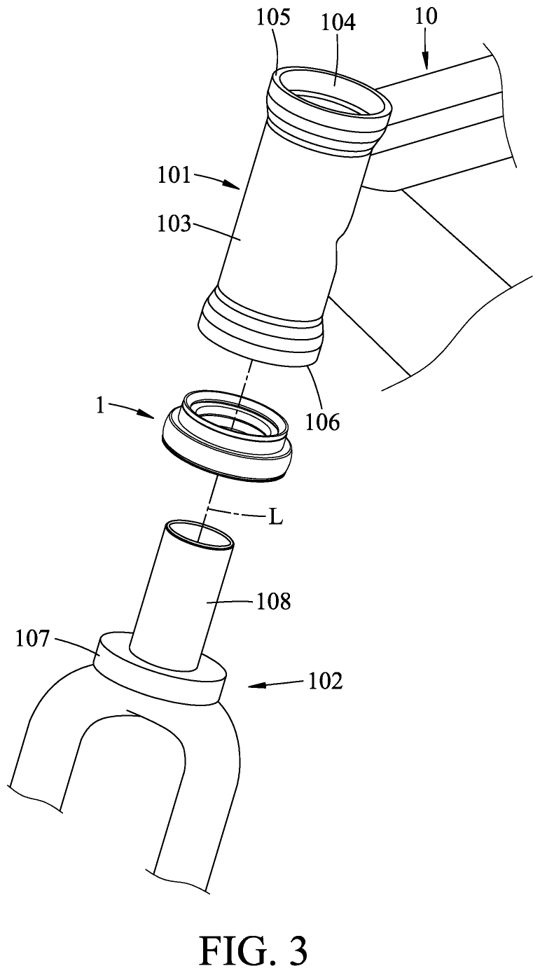

Referring to FIGS. 3 to 5, a head tube assembly 1 of an embodiment according to the present disclosure is adapted to be mounted between a head tube 101 and a front fork 102 of a vehicle 10. In this embodiment, the vehicle 10 is a bicycle (not shown) and is not limited hereto. The head tube 101 has an external surrounding surface 103, an inner surrounding surface 104 opposite to the external surrounding surface 103, an upper connecting end surface 105, and a lower connecting end surface 106. The upper connecting end surface 105 and the lower connecting end surface 106 are opposite along an axis (L), and each interconnecting the external surrounding surface 103 and the inner surrounding surface 104. The front fork 102 extends through the head tube 101, is rotatable relative to the head tube 101 about the axis (L), and includes a receiving seat 107 and a tube portion 108 connected to the receiving seat 107 and inserted into the head tube 101.

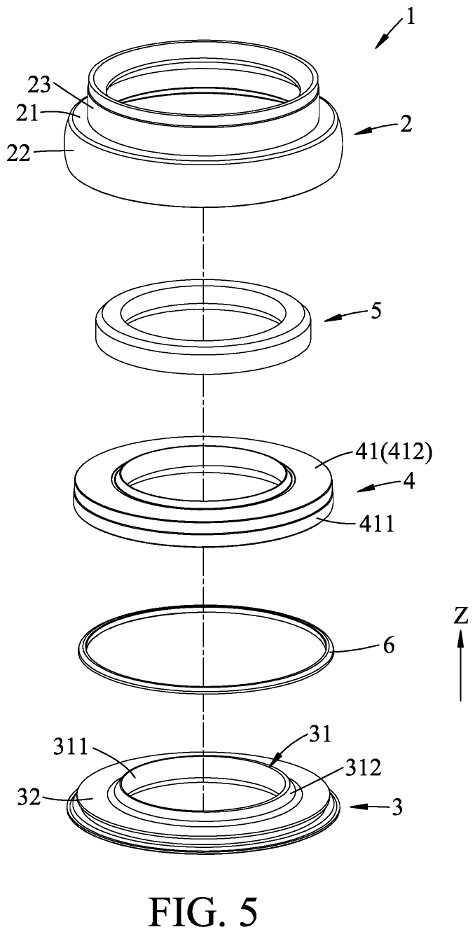

As shown in FIG. 5, the head tube assembly 1 includes a cup member 2, an insertion member 3, a damping unit 4, a bearing unit 5, and a sealing member 6.

It should be noted that, in this embodiment, the head tube assembly 1 of this disclosure serves as a lower head tube assembly for the vehicle 10 in an up-down direction (Z) of the axis (L), so the head tube assembly 1 is mounted on the lower connecting end surface 106 of the head tube 101, but the present disclosure is not limited thereto. In other embodiments, the head tube assembly 1 of this disclosure may be mounted to the upper connecting end surface 105 in the up-down direction (Z) to serve as an upper head tube assembly for the vehicle 10.

The cup member 2 is adapted to be fixed to an end of the head tube 101 that is proximate to the lower end surface 106. The cup member 2 includes a fixed base wall 21 adapted to abut against the lower connecting end surface 106, a fixed outer wall 22 connected to and extending downwardly from the fixed base wall 21, a fixed inner wall 23 connected to one end of the fixed wall 21 that is opposite to the fixed outer wall 22 along the axis (L) and in a radial direction transverse to the axis (L), and a positioning wall 24 extending inclinedly and radially inwardly from an inner surface of the fixed inner wall 23 and opposite to the fixed outer wall 22 along the axis (L). The fixed inner wall 23 is adapted to press fittingly against the inner surrounding surface 104.

The insertion member 3 is adapted to be connected co-rotatably to the front fork 102 and includes an insertion body 31 adapted to be sleeved on the tube portion 108, and an annular cover body 32 extending radially and outwardly from the insertion body 31 and adapted to be seated on the receiving seat 107. The insertion body 31 has an inner abutment surface 311 that is adapted to abut against an outer surface of the tube portion 108, and an outer connecting surface 312 that is connected to the inner abutment surface 311 and the annular cover body 32. The sealing member 6 is sleeved on the annular cover body 32 and is clamped between the annular cover body 32 and the cup member 2. In this embodiment, the cover body 32 covers a bottom portion of the cup member 2.

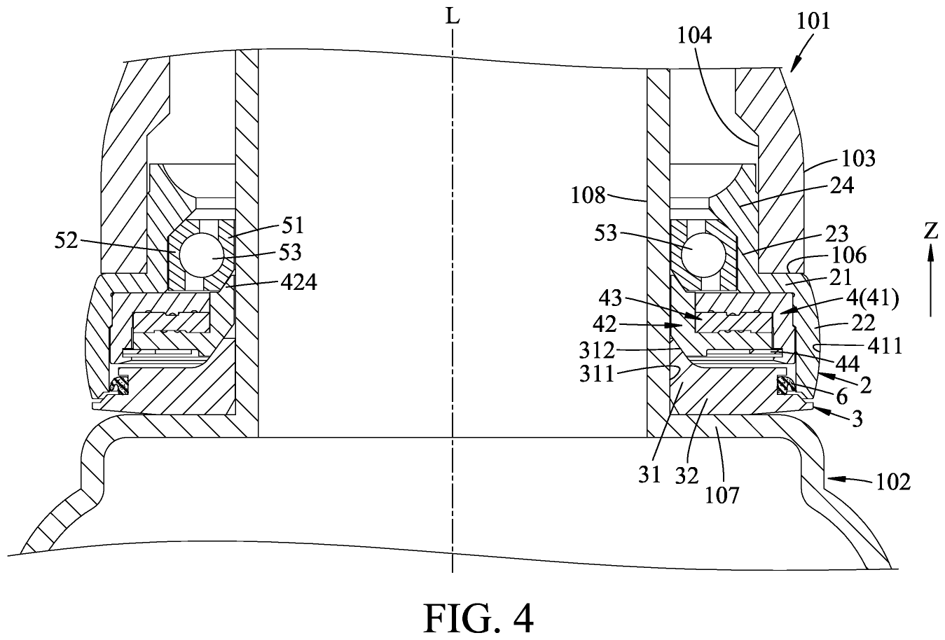

Referring to FIGS. 4 to 6, the damping unit 4 is disposed between the cup member 2 and the insertion member 3, and is connected to the insertion member 3. The damping unit 4 includes an outer seat 41 connected fixedly to the cup member 2, an inner seat 42 connected co-rotatably to the insertion member 3 about the axis (L), a bushing 43 mounted on the axis (L) between the outer seat 41 and the inner seat 42, and a retaining member 44. The outer seat 41 and the inner seat 42 are in frictional contact with the bushing 43 and are rotatable relative to the bushing 43 about the axis (L).

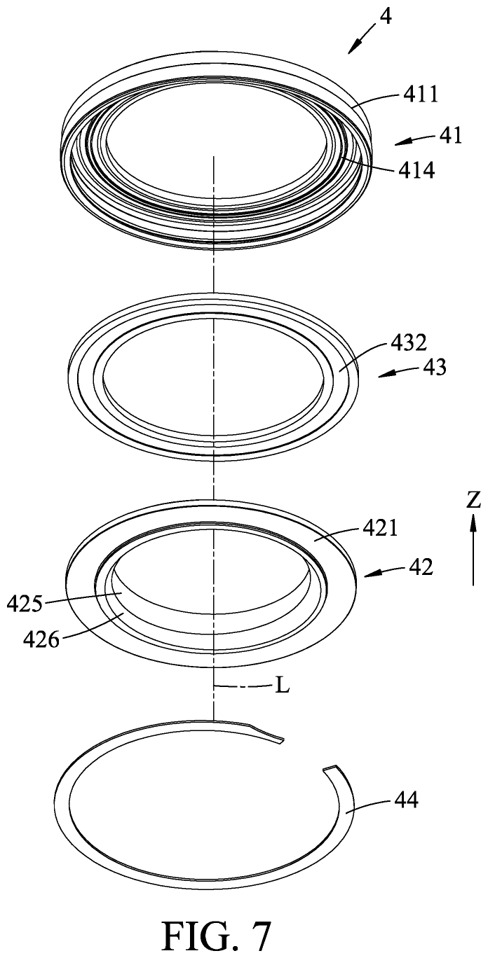

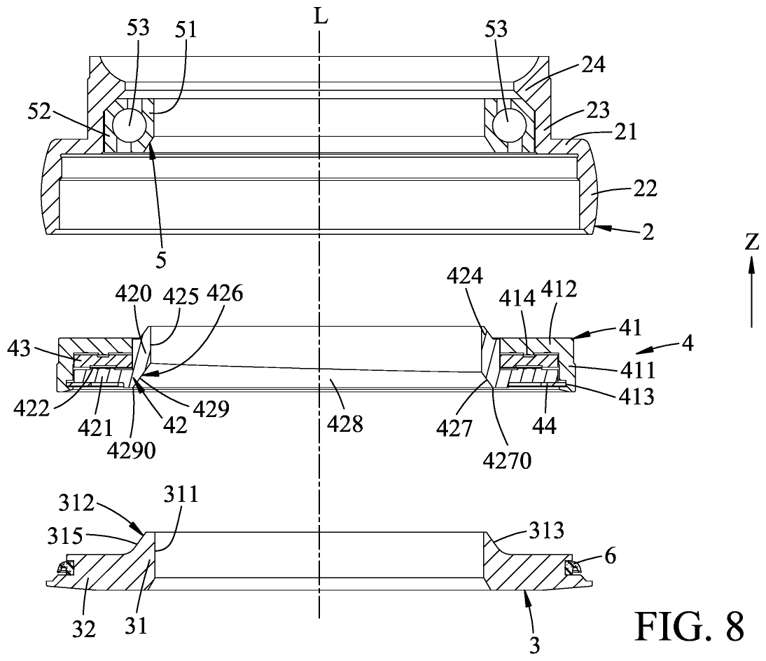

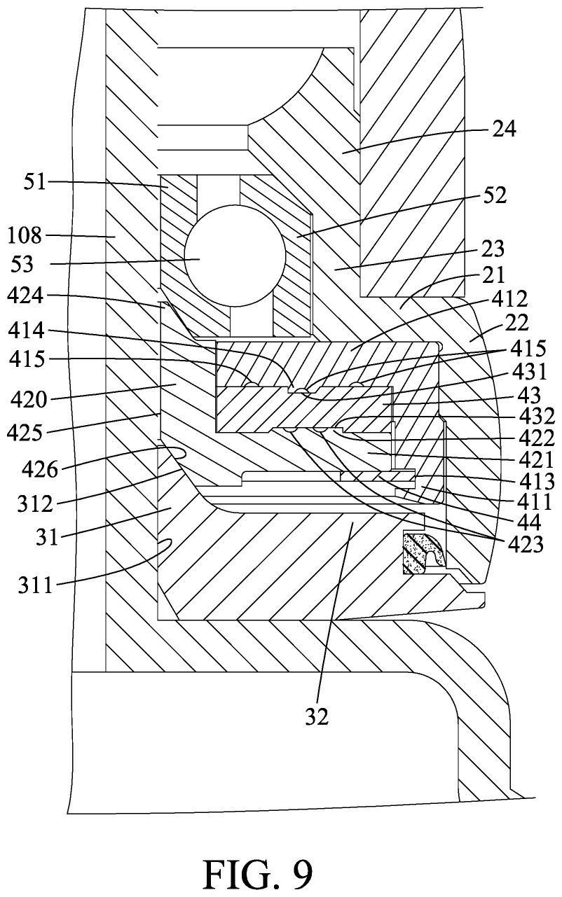

Further referring to FIGS. 7 to 8, the outer seat 41 includes an outer surrounding wall 411, an outer base wall 412, and an outer annular rib 414. The outer surrounding wall 411 abuts against and is surrounded by an inner surface of the fixed outer wall 22 of the cup member 2. The outer base wall 412 extends radially and inwardly from the outer surrounding wall 411 and is in frictional contact with the bushing 43. The outer annular rib 414 is formed on the outer base wall 412 and is adjacent to the bushing 43. The outer seat 41 has an engaging groove 413 formed in an inner surface of the outer surrounding wall 411 and opposite to the outer base wall 412 along the axis (L), and a plurality of outer oil grooves 415 (see FIG. 9) formed in the outer base wall 412 and the outer annular rib 414. In this embodiment, the number of the outer oil grooves 415 is three.

As shown in FIG. 9, two of the outer oil grooves 415 are formed in an end surface of the outer base wall 412 that is adjacent to the bushing 43, and the remaining one of the first oil grooves 415 is formed in the first annular rib 414.

Referring to FIGS. 7 to 9, the inner seat 42 includes a seat body 420, an inner damping plate 421, a inner annular rib 422, and a protruding portion 424. The seat body 420 is adapted to surround the tube portion 108 of the front fork 102 and abuts against the insertion body 31. The inner damping plate 421 extends radially and outwardly from the seat body 420 and is in frictional contact with the bushing 43. The inner annular rib 422 protrudes from the inner damping plate 421 toward the bushing 43 and is formed with a plurality of inner oil grooves 423. The protruding portion 424 extends upwardly from an end surface of the seat body 420, is opposite to the inner damping plate 421 along the axis (L), and is radially opposite to the inner damping plate 421.

The seat body 420 of the inner seat 42 has an inner surface 425 and an inner connecting surface 426. The inner surface 425 is adapted to surround the tube portion 108 of the front fork 102, and is connected to and eccentric to the inner connecting surface 426. The inner connecting surface 426 abuts against the outer connecting surface 312 of the insertion body 31, and extends inclinedly, radially and outwardly from the inner surface 425. In this embodiment, each of the inner seat 42 and the insertion body 31 has an eccentric structure such that the insertion member 3 drives rotation of the inner seat 42 as being rotated.

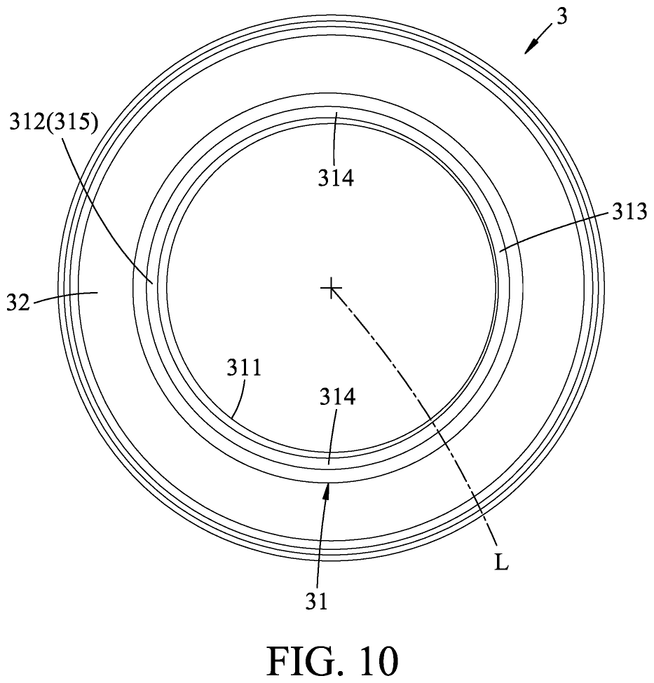

Referring to FIGS. 8 and 10, the eccentric structure of the insertion member 3 is to be described. The outer connecting surface 312 of the insertion body 31 has a large segment 315, a small segment 313 having a thickness in a radial direction transverse to the axis (L) that is smaller than that of the large segment 315, and two tapering segments 314 each having a thickness in the radial direction that tapers from the large segment 315 toward the small segment 313.

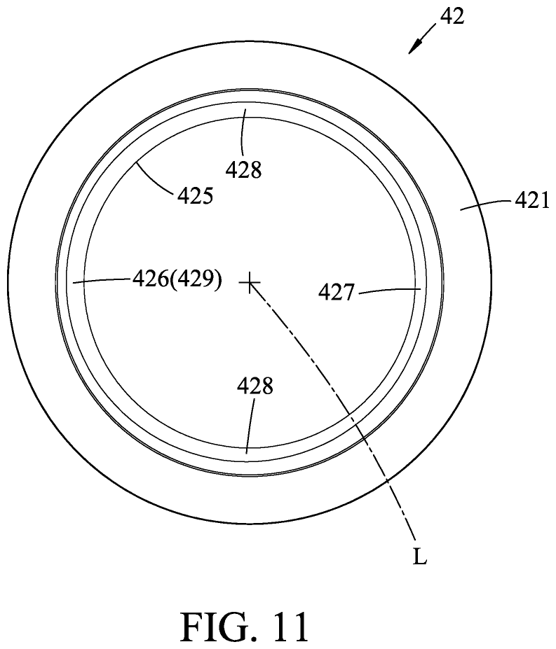

Referring to FIGS. 8 and 11, the eccentric structure of the inner seat 42 is to be illustrated. Specifically, the inner connecting surface 426 has a large section 429, a small section 427, and two tapering sections 428. The large section 429 abuts against the large segment 315 and has a distal end 4290 that is disposed opposite to the inner surface 425 in the radial direction. The small section 427 abuts against the small segment 313 and has a distal end 4270 that is opposite to the inner surface 425 in the radial direction and that is closer to the axis (L) in the radial direction than the distal end 4290 of the large section 429. Each of the tapering sections 428 tapers from the large section 429 toward the small section 427 and abuts against a respective one of the tapering segments 314 of the insertion body 31.

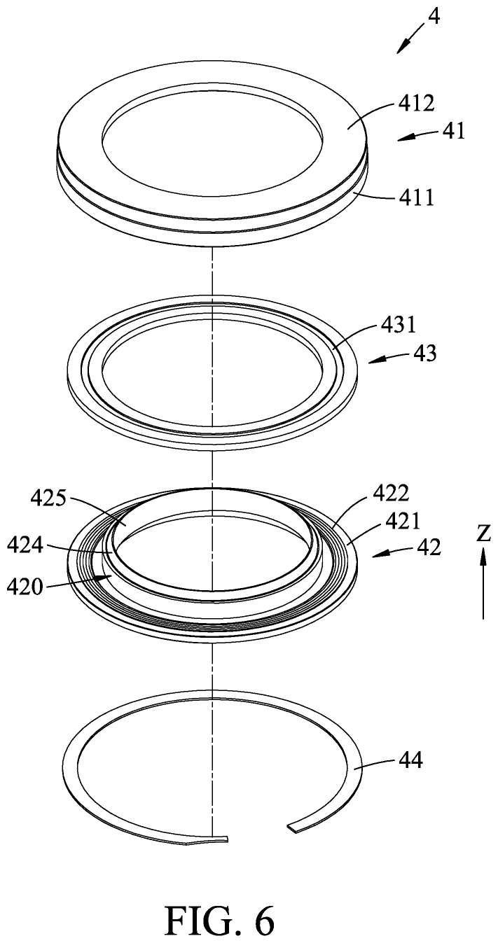

Referring to FIGS. 6, 7 and 9, the bushing 43 is disposed between the outer base wall 412 and the inner damping plate 421, and has an upper end surface adjacent to the outer base wall 412 and a lower end surface adjacent to the inner damping plate 421. The upper end surface of the busing 43 is formed with an upper annular groove 431 that engages with the annular rib 414 of the outer seat 41. The lower end surface of the bushing 43 is formed with a lower annular groove 432 that engages with the inner annular rib 422. In this way, the bushing 43 is concentric to the outer seat 41 and the inner seat 42. It should be noted that the number of each of the inner annular rib 422, the lower annular groove 432, the upper annular groove 431 and the annular rib 414 may be two or more in other embodiments and is not limited to this example as long as the bushing 43 is concentric to the inner seat 42 and the outer seat 41.

As shown in FIGS. 6 to 9, the retaining member 44 is a C-ring engaging the engaging groove 413, abutting against the inner damping plate 421, and retaining the inner seat 42 and the bushing 43 in the outer seat 41.

Now referring to FIGS. 4 and 9, the bearing unit 5 is a ball bearing disposed between the damping unit 4 and the cup member 2. The bearing unit 5 includes an inner ring 51 abutting against the protruding portion 424, an outer ring 52 abutting against the positioning walls 24, and a plurality of rollers 53 disposed between the inner ring 51 and the outer ring 52.

As shown in FIG. 4, the sealing member 6 is sleeved on the annular cover body 32, and is clamped between the annular cover body 32 and the fixed outer wall 22 of the cup member 2 to prevent liquid or foreign matters from entering the cup member 2 to thereby prevent failure of the damping unit 4.

With reference to FIGS. 3, 4 and 9, when the tube portion 108 of the front fork 102 rotates relative to the head tube 101 about the axis (L), the inner damping plate 421 is driven to rotate with the insertion member 3, and is in frictional contact with and rotatable relative to the bushing 43 so a damping effect is provided. On the other hand, when the outer seat 41 is driven to rotate with the cup member 2 due to rotation of the head tube 101 relative to the tube portion 108 of the front fork 102 about the axis (L), the base wall 412 is in frictional contact with the bushing 43 and is rotatable relative to the bushing 43 so a damping effect is also provided. In this embodiment, a thin layer of grease such as a lubricating oil is applied between the retaining member 44 and the inner damping plate 421 of the inner seat 42, between the inner damping plate 421 and the bushing 43, between the bushing 43 and the outer base wall 412 of the outer seat 41, and in the outer oil grooves 415 and the inner oil grooves 423 so as to decrease frictional force thereamong and to improve the damping effect of the damping unit 4 when the front fork 102 rotates relative to the head tube 101 and vice versa.

By virtue of the eccentric structure of each of the inner seat 42 and the insertion body 31, a frictional force between the inner connecting surface 426 and the outer connecting surface 312 is sufficient to enable co-rotation of the inner seat 42 and the insertion body 31 even if a manufacturing error occurs. Specifically, when the outer connecting surface 312 skids on and rotates relative to the inner connecting surface 426, the large segment 315 of the insertion body 31 abuts against either one of the tapering sections 428 of the inner connecting surface 426 so the inner seat 42 is still capable of co-rotating with the insertion body 31, and thus the inner damping plate 421 rotates relative to and is in frictional contact with the bushing 43 to provide a damping effect. In a case where each of the inner seat 42 and the insertion body 31 has a concentric structure, a contact area between the inner connecting surface 426 and the outer connecting surface 312 may be decreased when a manufacturing error occurs. Consequently, a frictional force between the inner connecting surface 426 and the outer connecting surface 312 may be insufficient to enable co-rotation of the inner seat 42 and the insertion body 31. For example, in such case, when the insertion body 31 co-rotates with the tube portion 108 of the front fork 102, the outer connecting surface 312 may continuously skid on and rotate relative to the inner connecting surface 426, thus the inner seat 42 is not capable of being driven to rotate and providing a damping effect.

To assemble the head tube assembly 1 of the present disclosure to the vehicle 10, the bearing unit 5 is first placed in the cup member 2 so the outer ring 52 abuts against the positioning wall 24, and then the damping unit 4 is placed into the cup member 2 so the protruding portion 424 abuts against the inner ring 51, and the outer surrounding wall 411 abuts against and is surrounded by the inner surface of the fixed outer wall 22 to position the damping unit 4 in the cup member 2. Subsequently, the cup member 2 that is equipped with the bearing unit 5 and the damping unit 4 is inserted into the head tube 101 so the fixed inner wall 23 presses fittingly against the inner surrounding surface 104 of the head tube 101. Hereafter, the insertion member 3 is sleeved on the tube portion 108 of the front fork 102 with the annular cover body 32 seated on the receiving seat 107. Then, the front fork 102 is inserted into the head tube 101 with the large segment 315 and the small segment 313 of the outer connecting surface 312 respectively abutting against the large section 429 and the small section 427 of the inner connecting surface 426 so the insertion body 31 engages the inner seat 42. Finally, the annular cover body 32 on which the sealing member 6 is sleeved covers the bottom portion of the cup member 2 so the sealing member 6 is clamped between the annular cover body 32 and the fixed outer wall 2 of the cup member 2 to complete assembly of the head tube assembly 1 to the vehicle 10.

As shown in FIG. 8, it should be noted that, the damping unit 4 has a relatively simple structure and may be assembled independently and separately from other components of the head tube assembly 1. During assembly of the damping unit 4 that is performed in advance of mounting of the head tube assembly 1 to the vehicle 10, the bushing 43 is first placed in the outer base wall 412, and then the inner seat 42 is disposed on the bushing 43. Finally, the retaining member 44 is disposed in the engaging groove 413 to retain the inner seat 42 and the bushing 43 in the outer seat 41 and thus the assembly of the damping unit 4 is completed. As shown in FIG. 9, by virtue of the outer annular rib 414 that engages the upper annular groove 431, the bushing 43 is positioned relative to the base wall 412. Furthermore, the structure of the inner annular rib 422 that engages the lower annular groove 432 facilitates the bushing 43 to be positioned relative to the inner damping plate 421.

In summary, by virtue of the damping unit 4 that has a relatively simple structure and that may be assembled independently and separately from other components of the head tube assembly 1, it is easy to assemble the head tube assembly 1 of the present disclosure to the vehicle 10, and maintenance of the head tube assembly 1 is simple and convenient. Furthermore, due to eccentric structure of each of the insertion body 31 and the inner seat 42, the insertion member 3 is capable of driving rotation of the inner seat 42 even if a manufacturing error occurs, such that the damping unit 4 effectively provides a damping effect.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A head tube assembly adapted to be mounted between a head tube and a front fork of a vehicle, the front fork extending through the head tube and said head tube assembly and rotatable relative to the head tube about an axis, said head tube assembly comprising:
a cup member that is adapted to be mounted fixedly to the head tube;
an insertion member that is adapted to be connected co-rotatably to the front fork, and that includes an insertion body having
an inner abutment surface that is adapted to abut against said front fork, and
an outer connecting surface that is connected to said inner abutment surface; and
a damping unit disposed on the axis between said cup member and said insertion member, connected to said insertion member, and including
an outer seat that is fixedly connected to said cup member,
an inner seat that is connected co-rotatably to said insertion member and that has an inner connecting surface that abuts against said outer connecting surface of said insertion body, and
a bushing that is mounted on the axis between said outer seat and said inner seat, said outer seat and said inner seat being in frictional contact with said bushing and rotatable relative to said bushing about the axis;
wherein each of said inner seat and said insertion body has an eccentric structure such that said insertion member drives rotation of said inner seat as being rotated.

2. The head tube assembly as claimed in claim 1, wherein:
said inner abutment surface is eccentric to said outer surrounding surface,
said insertion body has a large segment and a small segment having a thickness in a radial direction transverse to the axis that is smaller than a thickness of said large segment,
said inner seat has an inner surface connected to and eccentric to said inner connecting surface,
said inner connecting surface has
a large section abutting against said large segment and having a distal end that is disposed opposite to said inner surface in the radial direction, and
a small section abutting against said small segment and having a distal end that is opposite to said inner surface in the radial direction and that is closer to the axis in the radial direction than said distal end of said large section.

3. The head tube assembly as claimed in claim 1, wherein:
said inner seat includes
a seat body adapted to surround the front fork, abutting against said insertion body, and having
an inner surface that is adapted to surround the front fork, and
said inner connecting surface that extends inclinedly, radially, and outwardly from said inner surface, and
an inner damping plate extending radially and outwardly from said seat body, and being in frictional contact with said bushing.

4. The head tube assembly as claimed in claim 3, wherein:
said outer seat includes
an outer surrounding wall abutting against and surrounded by said cup member, and
an outer base wall extending radially and inwardly from said outer surrounding wall, surrounding said seat body of said inner seat, cooperating with said inner damping plate to clamp said bushing therebetween, and in frictional contact with said bushing.

5. The head tube assembly as claimed in claim 4, wherein:
said outer sea includes an outer annular rib disposed on said outer base wall and adjacent to said bushing;
said bushing has an upper end surface adjacent to said outer base wall and formed with an upper annular groove that engages said annular rib.

6. The head tube assembly as claimed in claim 5, wherein:
said outer seat has a plurality of outer oil grooves formed in said outer base wall and said outer annular rib.

7. The head tube assembly as claimed in claim 4, wherein:
said outer seat has an engaging groove formed in an inner surface of said outer surrounding wall and opposite to said outer base wall along the axis;
said damping unit further includes a retaining member engaging said engaging groove, abutting against said inner damping plate, and retaining said inner seat and said bushing in said outer seat.

8. The head tube assembly as claimed in claim 4, wherein:
said cup member includes
a fixed base wall disposed on said outer base wall,
a fixed outer wall connected to said fixed base wall and surrounding said outer surrounding wall,
a fixed inner wall connected to one end of said fixed base wall that is opposite to said fixed outer wall along the axis and in a radial direction transverse to the axis, and
a positioning wall extending inclinedly and radially inwardly from an inner surface of said fixed inner wall and opposite to said fixed outer wall along the axis;
said inner seat further includes a protruding portion extending from said seat body, opposite to said inner damping plate along the axis, and radially opposite to said inner damping plate; and
said head tube assembly further comprises a bearing unit disposed between said positioning wall and said protruding portion.

9. The head tube assembly as claimed in claim 3, wherein:
said inner seat includes an inner annular rib protruding from said inner damping plate toward said bushing, and formed with a plurality of inner oil grooves; and
said bushing has a lower end surface adjacent to said inner damping plate and formed with a lower annular groove that engages with said inner annular rib.

10. The head tube assembly as claimed in claim 1, wherein:
said insertion member further includes an annular cover body extending radially and outwardly from said outer connecting surface of said insertion body; and
said head tube assembly further comprises a sealing member sleeved on said annular cover body and clamped between said annular cover body and said cup member.
